(19) United States
(12) Patent Application Publication
(10) Pub. No.: US 2012/0166657 A1
(43) Pub. Date: Jun. 28, 2012

(54) GATEWAY SYSTEM, GATEWAY DEVICE, AND LOAD DISTRIBUTION METHOD

(75) Inventor: KUNIHIKO TOUMURA, Hachioji (JP)

(73) Assignee: Hitachi, Ltd.

(21) Appl. No.: 13/224,755

(22) Filed: Sep. 2, 2011

(30) Foreign Application Priority Data
Dec. 22, 2010 (JP) 2010-285288

(51) Int. Cl. G06F 15/16

(52) U.S. Cl. 709/228

(57) ABSTRACT

A gateway system comprises a first packet relay device and a plurality of gateway devices. The first packet relay device determines the gateway device serving as a destination of a packet based on destination information of the packet. The gateway device determines a gateway device in charge of processing the packet based on transmission source information of the packet, and if the gateway device in charge of processing the packets is other gateway device, the gateway device transmits this packet to this other gateway device.

### INCORPORATION BY REFERENCE

This application claims priority based on a Japanese patent application. No. 2010-285288 filed on Dec. 22, 2010, the entire contents of which are incorporated herein by reference.

### BACKGROUND

The subject matter disclosed herein relates to distribution construction methods in a large-scale gateway device or server system.

A server system providing services on the Internet or a gateway system providing added values to a user terminal via a service provider is beginning to be exposed to a very large load with the proliferation and speeding-up of networks. In such a system, two main methods are used to respond to an increase in the load. The first one is a method of improving the performance of each component, called a “scale-up performance expansion”. The second one is a method of increasing the number of components, and called a “scale-out performance expansion”. Usually, in the latter method, the system configuration tends to be complicated as compared with the former one while following variations of a load is easy. Therefore, the current server system and gateway system often employ the scale-out system configuration.

In the scale-out system, it is an important technique to arrange a large number of homogeneous components and uniformly distribute loads across these components. In order to realize this, a device, called a load balancer, specific to a distribution function is often used. The load balancer is arranged in the preceding stage of a subject to be served. Then, a request from a user to final is once received by a small number of load balancers, and this request is transferred to a server or a gateway device serving under the load balancer by using various kinds of information included in this request.

In order for a load balancer to carry out uniform load distribution, a method of randomly determining an allocation destination simply in the unit of packet is insufficient, and it is necessary to adequately utilize the information included in a request from a user terminal. For example, the allocation destination can be determined using an IP address, a port number, and URL, cookie information, and the like included in an HTTP request. For example, a server in charge is determined based on an IP address on the user terminal side included in a packet, so that the communication related to a specific user terminal is always assigned to the same server. At this time, use of information of a high layer (e.g., URL of HTTP) makes it possible to carry out a more detailed load distribution specific to an application, but this leads to complication of the processing in a load balancer and therefore the processing performance of the load balancer itself tends to degrade. In cases where the load distribution is carried out using a small number of load balancer, if the performance of the load balancer itself is low, the load balancer may result in a bottleneck of the whole system, which therefore should be avoided. Moreover, in order to carry out complicated processing, it is necessary to hold a lot of information in a device, which makes it difficult to take over the processing in case of device failure.

In JP-A-2003-174473, in a relay device in the preceding stage of a load balancer, a transfer destination interface of the load balancer is determined based on a hash value of an IP address on a user terminal side, and further in the load balancer, the processing is distributed across the target servers. Thus, a primary distribution is carried out based on a simple distribution rule and then a secondary distribution is further carried out by the load balancers, thereby making it possible to place a large number of load balancers and resolving the above-described bottleneck problem caused by the load balancer.

### SUMMARY

However, in the distribution method according to JP-A-2003-174473, the relay device in the preceding stage needs to have a function which a commercially available inexpensive relay device does not have, and if in order to realize the method of JP-A-2003-174473, a device with a high-speed packet processing function realized by hardware or the like needs to be independently created, which causes an increase in the cost of the whole load distribution system. In addition, a reduction in the management cost for an increase or decrease in the number of load distribution-target servers or gateways, the reduction being an indispensable requirement for realizing the scale-out type performance improvement, cannot be realized.

That is, when the number of servers increases or decreases, a modification is required for a large number of components, and in addition, a takeover processing of a session, which is in process when the number of servers increases or decreases, cannot be realized. Therefore, the system needs to be stopped in order to increase or decrease the number of servers and it is practically impossible to flexibly add or delete a server. In addition, two steps of transfers from a router to a load balancer and from the load balancer to a server are always required, resulting in an increase of the load on each component.

Accordingly, when a complicated load balancer is used, the cost performance of the whole system degrades and the load balancer becomes a bottleneck or a single point of failure.

The disclosed a gateway system includes a first packet relay device and a plurality of gateway devices, wherein the first packet relay device includes: a packet processing section which determines the gateway device serving as a destination of a packet received via a network based on destination information of the packet; and a packet transmission/reception section transferring the packet to the gateway device, which is determined as the destination by the packet processing section, via a network. The gateway device includes: a packet processing section which, based on transmission source information of a packet received via a network, determines a gateway device in charge of processing the packet; and a packet transmission/reception section which, when the gateway device in charge of processing the packet is determined as other gateway device, transfers the packet to this other gateway device.

Moreover, the disclosed gateway device coupled to each other with a plurality of gateway devices via a network includes: “information on gateway devices in charge of processing a packet” indicative of a correspondence between transmission source information of a packet and information for identifying a gateway device in charge of processing the packet; a packet processing section which determines a gateway device in charge of processing a packet received via the network based on the “information on gateway devices in charge of processing a packet”; and a packet transmission/reception section which, when the gateway device in charge of processing the packet is determined as other gateway device, transfers this packet to this other gateway device.

Furthermore, the disclosed load distribution method in a gateway system, including a packet relay device and a plurality of gateway devices, includes the steps of: transferring, in the packet relay device, a packet received via a network to a gateway device which is determined based on destination information of this packet; determining, in the gateway device, based on the transmission source information of the packet, a gateway device in charge of processing the packet; and transferring, if the determined gateway device in charge of processing the packet is other gateway device, the packet to the determined other gateway device.

According to the teaching herein, load distribution can be realized without using a complicated load balancer. As a result, the cost performance of the whole system can be improved and the cost required for resolving a single point of failure can be reduced

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 exemplifies a block diagram of the whole system.

FIG. 2 exemplifies a block diagram of a packet relay device on a user terminal side.

FIG. 3 exemplifies a block diagram of a gateway device.

FIG. 4 exemplifies a flow chart upon receipt of a packet in the gateway device.

FIG. 5 exemplifies tables which a gateway management server stores.

FIG. 6 exemplifies an IP block table calculation process flow chart of a service providing device.

FIG. 7 exemplifies a sequence diagram of the initialization of the whole system and of the packet transfer.

FIG. 8 exemplifies a sequence diagram when a gateway device is added and packets are transferred to a session in process.

FIG. 9 exemplifies a sequence diagram in deleting a gateway device when the gateway management server is not placed.

FIG. 10 exemplifies a block diagram of a user terminal management server.

FIG. 11 exemplifies a block diagram of the gateway management server.

FIG. 12 exemplifies a diagram showing a procedure to create a service providing device IP block table.

### DETAILED DESCRIPTION OF THE EMBODIMENTS

### Embodiment 1

A first embodiment for implementing the load distributing concept is shown below. The first embodiment shows how to apply a gateway management server 107 to a centralized control gateway system.

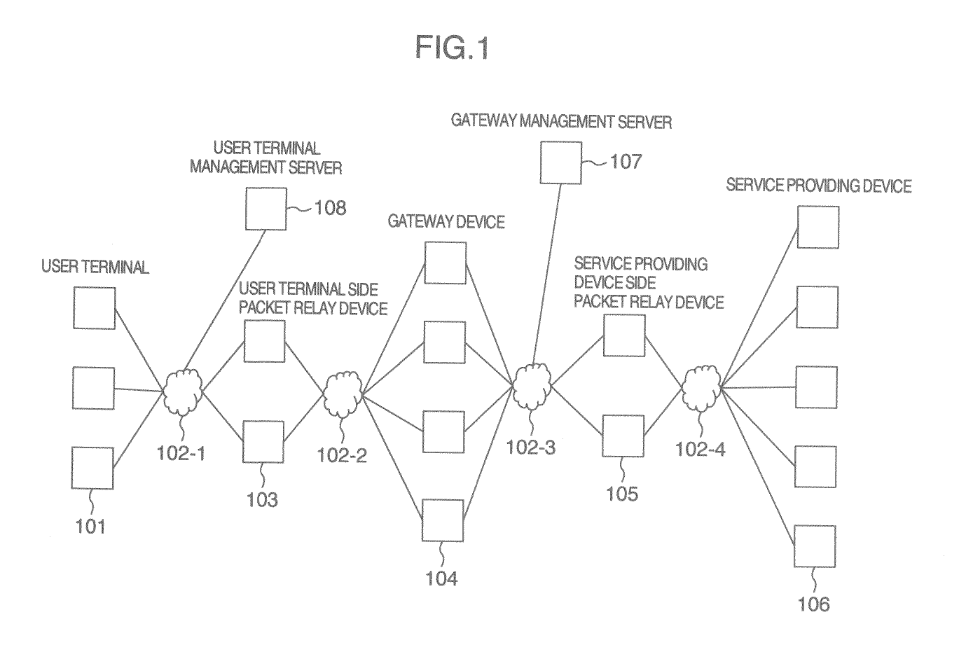

FIG. 1 shows the whole system block diagram of the Embodiment 1.

In this system, a user terminal 101 communicates with a service providing device 106 to receive services and an added value is provided by a gateway device 104 performing a mediation function. For example, the user terminal 101 corresponds to an internet accessible mobile phone, the service providing device 106 corresponds to a Web server on the Internet, and the gateway device 104 corresponds to a firewall of a communication carrier.

The user terminal 101 is coupled to a user terminal side packet relay device 103 via a network 102-1. The user terminal side packet relay device 103 is coupled to the gateway device 104 via a network 102-2. The gateway device 104 is coupled to a service providing device side packet relay device 105 via a network 102-3. The service providing device side packet relay device 105 is coupled to the service providing device 106 via a network 102-4. Moreover, a gateway device management device 107 is coupled to the gateway device 104 and the service providing device side packet relay device 105 via the network 102-3, and indirectly coupled to the user terminal side packet relay device, as well. Note that, the gateway management server 107 may be coupled to the networks 102 in any form as long as it can logically communicate with the user terminal side packet relay device 103, the gateway device 104, the service providing device side packet relay device 105, and the user terminal management server 108. The user terminal management server 108 is coupled to the user terminal 101 via the network 102-1.

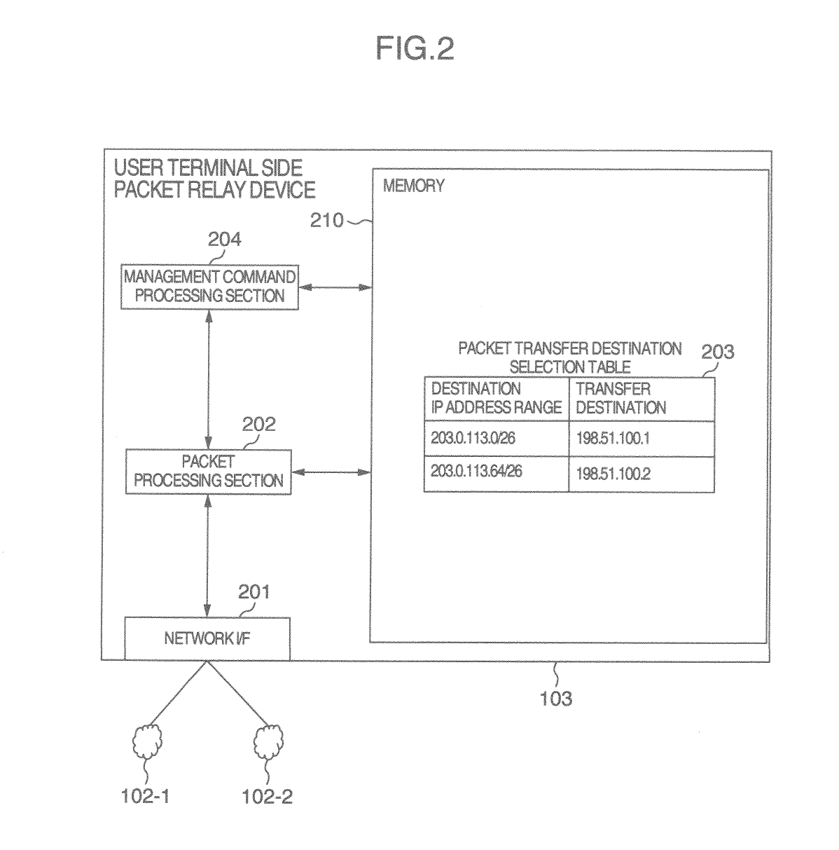

FIG. 2 is a block diagram of the user terminal side packet relay device 103. The user terminal side packet relay device 103 is coupled to a network 102-n via a network I/F 201, and transmits/receives packets between the user terminal side packet relay device 103 and each network 102. A packet processing section 202 analyzes a packet received by the network I/F 201, and searches a packet destination selection table 203 in a memory to determine a device to be transferred next, and transmits the received packet to an appropriate network 102. The user terminal side packet relay device 103 analyzes a packet received by the packet processing section 202, and as a result, if this packet is the one addressed to its own packet relay device, then this packet is processed by a management command processing section 204. The management command processing section 204 receives a management command from the gateway management server 107 or the gateway device 104 and carries out the update process and the like of the packet destination selection table 203.

The service providing device side packet relay device 105 has the same configuration as this one. The differences are an access network and the like.

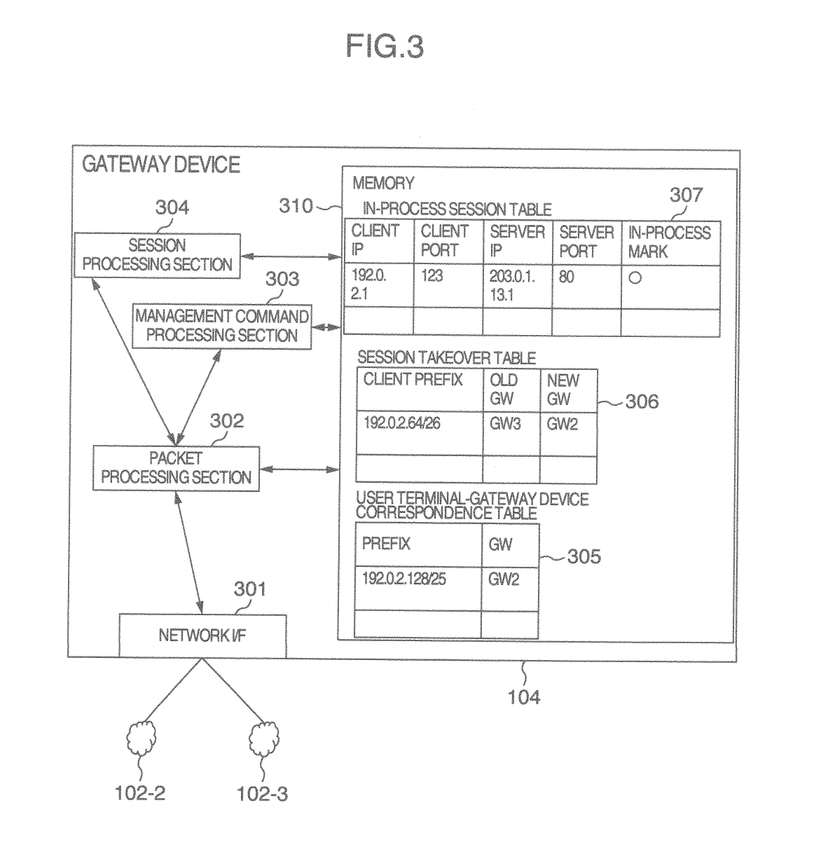

FIG. 3 shows a block diagram of the gateway device 104. The gateway device 104 comprises a network I/F 301, a packet processing section 302, a management command processing section 303, a session processing section 304, a user terminal-gateway device correspondence table 305, a session takeover table 306, and an in-process session table 307. Once the gateway device 104 receives a packet via the network 301, the packet processing section 302 analyzes this packet. As a result, if the packet is addressed to its own gateway device, the packet is transferred to the management command processing section 303, otherwise the tables in a memory are searched to determine the content to be processed. If there is a packet to be processed by its own gateway device, the packet is processed by the session processing section 304, and if it is the processing to be transferred to other gateway, the packet is transferred to this other gateway device via the network I/F.

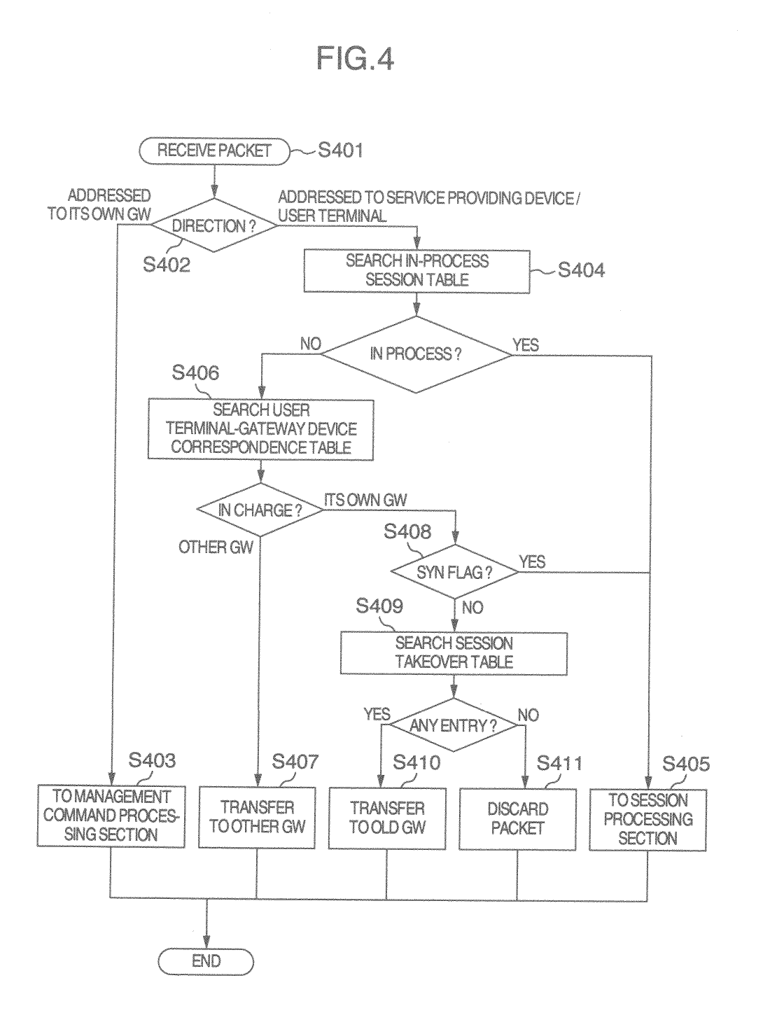

FIG. 4 shows a packet receiving process flow chart of the gateway device 104. A packet received by the network FT 301 (S401) is transferred to the packet processing section 302 and processed according to the flow chart of FIG. 4. First, the packet is analyzed to determine whether the packet is the one addressed to its own gateway device (S402). If the packet is addressed to its own gateway device, this packet is the one to be processed by the management command processing section 303 and therefore transferred to the management command processing section 303 (S403). Otherwise, that is, if this packet is addressed to the service providing device 106 or the user terminal 101, then in order to determine whether the packet is associated with a session in process by the relevant gateway device 104, the in-process session table 307 is searched with session information (in case of TCP, the IP address and port number of an opposing device are uniquely determined) as a key (S404).

As a result of the search, if there is an entry, this packet should be processed by its own gateway device and therefore this packet is transferred to the session processing section (S405). If this packet is not in process, a gateway device to be in charge of processing the packet needs to be determined. Therefore, the user to terminal-gateway device correspondence table 305 is searched with a transmission source address as a key if it is a packet from the user terminal 101 toward the service providing device 106, or with a destination address as a key if it is a packet from the service providing device 106 toward the user terminal 101 (S406).

As a result of the search, if other gateway device is found in charge of this packet, this packet is transferred to this other gateway device (S407). If its own gateway device is in charge of this packet, it is first determined whether this packet is a packet indicative of session initiation (in case of TCP, this can be determined to determine whether it is a packet that a SYN flag is set) (S408). If it is the session initiation packet, this packet is transferred to the session processing section (S405). If this packet is neither the session initiation packet nor in process by this gateway device, the session takeover table 306 is searched with a user terminal side address included in the packet as a key (S409). An old gateway device which might be previously in charge of this packet is found out, and this packet is transferred to this old gateway device (S410). In the case of a packet not having an entry in the session takeover table 306, this packet is recognized as an error packet and discarded (S411).

In the session processing section 304, when a SYN packet is received and the session processing is started, the information on this session is added to the in-process session table 307, and on the contrary, when the session is complete, the entry is deleted from the in-process session table 307.

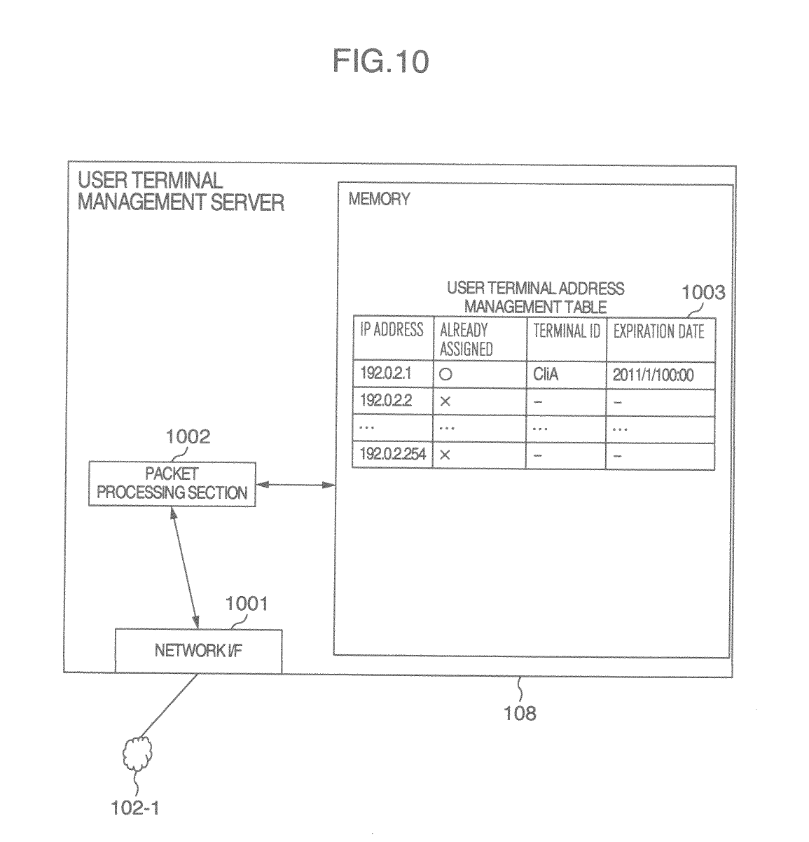

FIG. 10 shows a block diagram of the user terminal management server 108. The user terminal management server 108 is coupled to the network 102-1 via a network I/F 1001, and a packet transmitted/received between the user terminal management server 108 and the network 102-1 is processed by a packet processing section 1002. A packet processing section 1002 has a function to assign an IP address not overlapping with other terminal when each terminal couples to the network 102-1. For each of the IP addresses in an assigned range, a user terminal address management table 1003 manages information, such as whether its address is already assigned or to which terminal the address is assigned, or when the allocation expiration date is. The user to final management server 108, upon receipt of a network connection request from the user terminal 101 by the network I/F 1001, refers to the user terminal address management table 1003 in the packet processing section 1002, and if there is an unassigned IP address and an address has not been assigned yet to a terminal ID included in the request, the user terminal management server 108 assign the address to this terminal and updates the table.

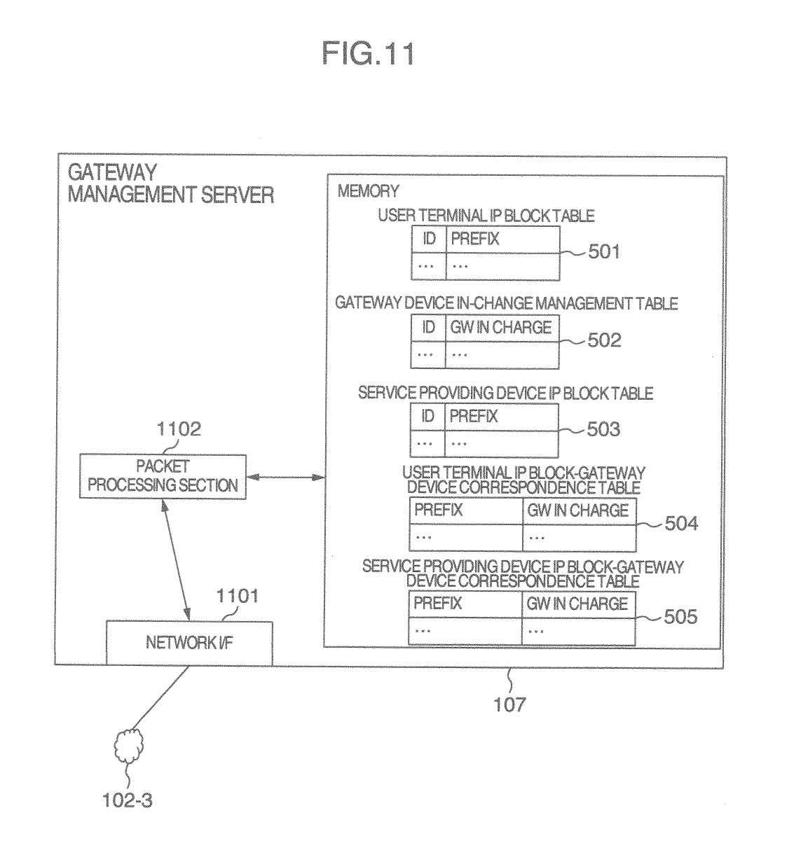

FIG. 11 shows a block diagram of the gateway management server 107. The gateway management server 107 is coupled to the network 102-3 via a network I/F 1101, and a packet transmitted/received between the gateway management server 107 and the networks 102-3 is processed by a packet processing section 1102. The gateway management server 107 has a function to manage and distribute the tables, which each of the gateway device 104, the user terminal side packet relay device 103, and the service providing device side packet relay device should have, to these devices.

The user terminal-gateway device correspondence table 305 in the gateway device 104 and the packet destination selection table in the user terminal side packet relay device 103 and service providing device side packet relay device 105 are created by the gateway management server and then distributed to each device. A method of creating each table is described below.

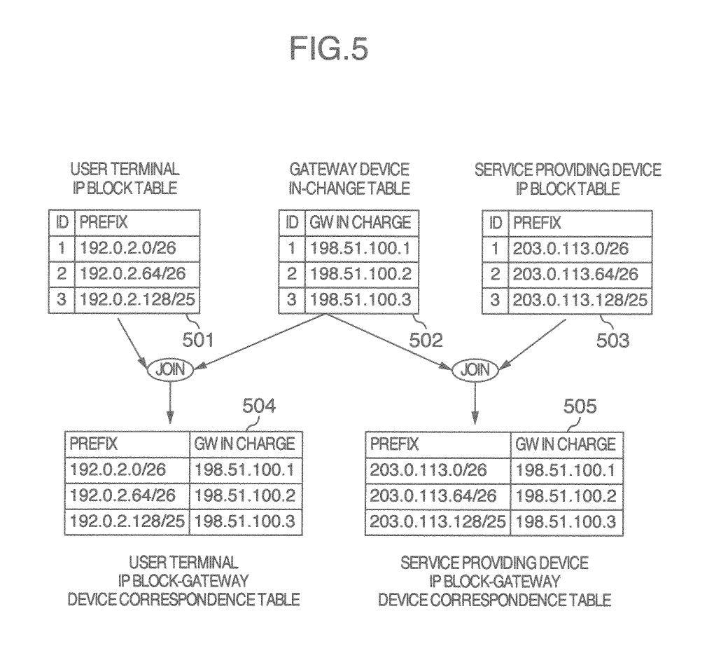

FIG. 5 shows a schematic view of the tables which the gateway management server 107 has and of how to create the tables. A user terminal IP block table 501 defines how to partition a user to final IP address space which a network administrator defined. Based on this each IP block, a request from a user is distributed to each gateway device. An in-charge gateway device table 502 is a table for storing the IP address of each gateway device which a network administrator manages. A service providing device IP block table defines how to partition the IP address space assigned to a service providing device side. As with the user terminal IP block table, based on this each IP block, a request from a user is distributed to each gateway device. A user terminal IP block-gateway device correspondence table 504 and a service providing device IP block-gateway device correspondence table 505 indicate which IP block is assigned to which gateway device.

In order to uniformly assign the user terminals 101 to the gateway device 104, there is a method that every time an address acquisition request is issued from a user terminal to the user terminal management server 108, addresses to be assigned to the user terminal 101 are uniformly distributed, for example, by replying an address which is extracted from a specific range of IP addresses using a uniform random number. In such a situation, if this specific range of IP addresses is uniformly divided and the resulting IP addresses are used for each entry of the user terminal IP block table 501, a packet from the user terminal 101 will correspond to each entry with a substantially equal probability.

If a gateway administrator can assign an address to the service providing device 106, then as with the user terminal IP block table 501, an IP address range allocated to the service providing device may be uniformly divided to create the service providing device IP block table 503.

In order to uniformly distribute a load when the address allocation to the service providing device 106 is not under management of a gateway administrator, the following method is taken. First, using some sort of method, the probability that a packet to each IP address or to an IP address range passes through the gateway device 106 is obtained. For example, statistical information of a packet may be obtained in a router present between a user terminal and a service providing device or the probability may be obtained using an access log of each service providing device. Here, a procedure to create the service providing device IP block table 503 is described in a state where the statistical information for each IP prefix expressed with the upper 16 bits of an IP address is already acquired.

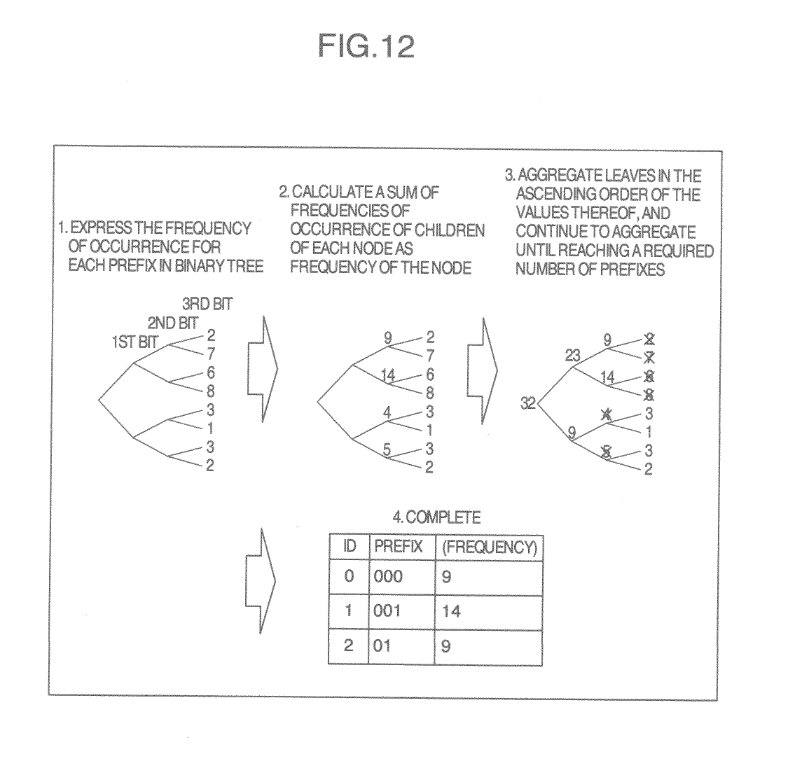

FIG. 12 shows an overview of this procedure. Here is a simplified view with a bit sequence of 3 bits. In this view, the upward branch represents 0 and the downward branch represents 1. For example, FIG. 12-1 shows that the frequency of occurrence of 000 is 2 and the frequency of occurrence of 001 is 7. In FIG. 12-2, a sum of the frequencies of occurrence of children of each node is calculated as the frequency of this node. For example, the frequency of occurrence of a prefix 00 is a sum of the frequencies of occurrence of 000 and 001 and therefore the frequency of occurrence is 2+7=9. Then, a node with the minimum frequency of occurrence is aggregated as a leaf and this operation is continued until the number of leaves reaches a required number of prefixes. At a time point when it becomes the required number, the service providing device IP block table is created based on this result.

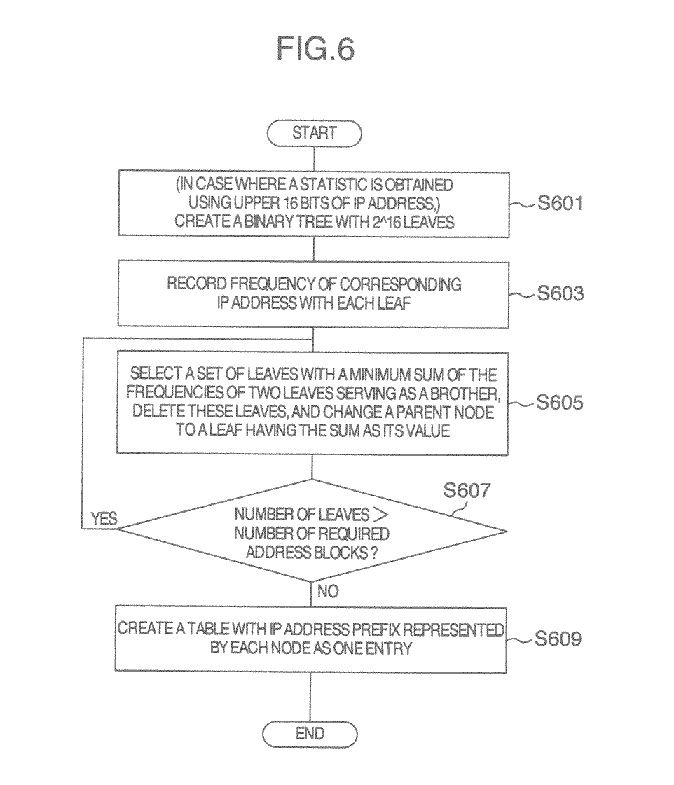

FIG. 6 shows the details of the procedure to create the service providing device IP block table 503. First, a perfect binary tree with 2̂16 leaves is created (S601). This is a tree with depth 16. If a value is assigned in a manner that 1 is assigned to the rightward branching direction of each node of the tree and 0 is assigned to the leftward branching direction, then a path reaching a leaf from the root of the tree can be expressed with a 16-bit binary number. This 16-bit binary number is associated with an IP prefix, and the frequency of occurrence of an IP prefix corresponding to each leaf is recorded (S603). Then, among all the leaves, a set of leaves with the minimum sum of the frequencies of two leaves serving as a brother is searched for, and these levees are deleted and the node of the parent of the brother is set to a new leaf having the sum of the frequencies of the brother as a value (S605). This operation is repeated until the number of leaves reaches the required number of address blocks (S607). Then, an IP prefix represented by the remaining leaf is an entry of the service providing device IP block table 503 (S609). Thus, a packet from the user terminal 101 corresponds to each entry with a substantially equal probability.

To the contrary, a case may be contemplated where uniform allocation is not required for some purpose. The examples of this include a case where a specific user is processed by a predetermined gateway device so that a special service is provided to this user. In such a case, the user terminal management server 108 assigns an address from a predetermined IP block in response to an address acquisition request from a specific user. Then, the gateway device 104 corresponding to this IP block is fixed, so that a gateway device in charge of the specific user can be fixed.

Using the table created heretofore, one gateway device 104 is assigned to one or more entries of the user terminal IP block table 501, so that the user terminal IP block-gateway device correspondence table 504 can be created. Moreover, one gateway device 104 is assigned to one or more entries of the service providing device IP block table, so that the service providing device IP block gateway device correspondence table 505 can be created.

The user terminal IP block-gateway device correspondence table 504 is transmitted from the gateway management server 107 to the gateway device 104, so that an initial value of the user terminal-gateway device correspondence table 305 which the gateway device 104 has can be determined. Moreover, the user terminal IP block-gateway device correspondence table 504 is transmitted from the gateway management server 107 to the service providing device side packet relay device 105, so that an initial value of the packet destination table 203 which the service providing device side packet relay device 105 has can be determined. Similarly, the service providing device IP block-gateway device correspondence table 505 is transmitted from the gateway management server 107 to the user terminal side packet relay device 103, so that an initial value of the packet destination selection table 203 of the user terminal side packet relay device 103 can be determined.

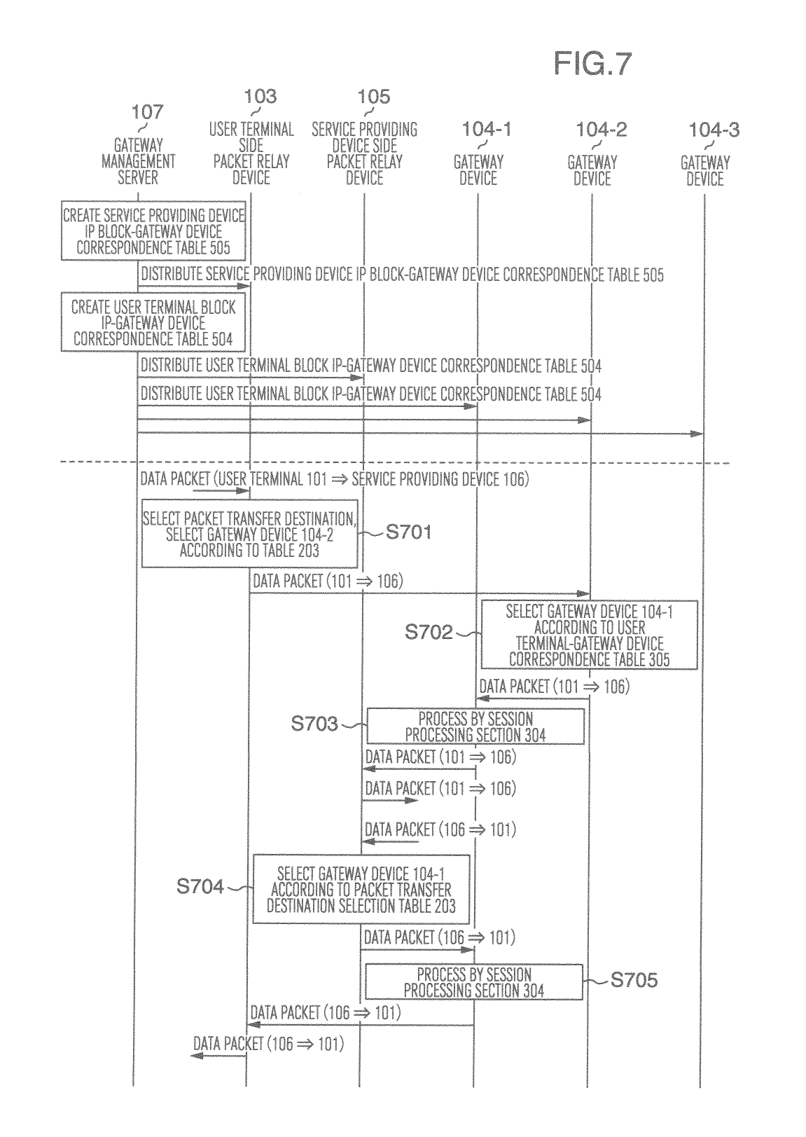

FIG. 7 shows the distribution of initialization information for the tables and a flow of packets from the user terminal 101 to the service providing device 106. Here, the flow of packets in the latter half is described step-by-step. Once a packet is transmitted from the user terminal 101 toward the service providing device 106, this packet first reaches the user terminal side packet relay device 103. In the user terminal side packet relay device 103, a device to which the packet is to be transferred next is selected according to the packet destination selection table 203 (S701). Here, assume the gateway device 104-2 is selected. Then, the user terminal side packet relay device 103 transmits this packet to the gateway device 104-2. Upon receipt of this packet, the gateway device 104-2 processes this packet according to the flow shown in FIG. 4 (S702). Here, suppose that this packet is not associated with an in-process session of the gateway device 104-2 and that the gateway device 104-1 which is other gateway device is in charge of this packet. Therefore, this packet is transferred to the gateway device 104-1. Upon receipt of this packet, the gateway device 104-1 processes this packet according to the flow of FIG. 4, and the intended gateway processing is carried out by the session processing section (S703). If this packet is the one indicative of the start of a session, then at this point, the session information is registered with the in-process session table 307, while if it is the one indicative of the end of a session, the entry of a session, which is already registered with the in-process session table 307, is deleted. The packet having been processed by the session processing section 304 is transmitted to the service providing device 106 via the service providing device side packet relay device 105.

A reply packet from the service providing device 106 to the user terminal 101 transmitted first reaches the service providing device side packet relay device 105. Assume that in the service providing device side packet relay device 105, the gateway device 104-1 has been selected according to the packet destination selection table 203 (S704). The reply packet is transferred to the selected gateway device 104-1, and the selected gateway device 104-1 processes the packet in the session processing section 304 according to the flow of FIG. 4 (S705). The packet having been processed in the session processing section 304 is transmitted to the user terminal 101 via the user terminal side packet relay device 103.

Since the destination determination in the service providing device side packet relay device 105 is made based on the IP address of the user terminal 101 which is the destination address, the packet is surely transferred to the gateway device 104 in charge by one time transfer. In a typical application, the amount of data from the service providing device 106 toward the user terminal 101 is significantly large as compared with the amount of data from the user terminal 101 toward the service providing device 106 and therefore the number of times of transfer between the gateway devices 104 with respect to a packet from the service providing device 106 is small, which is significantly effective in reducing the processing cost.

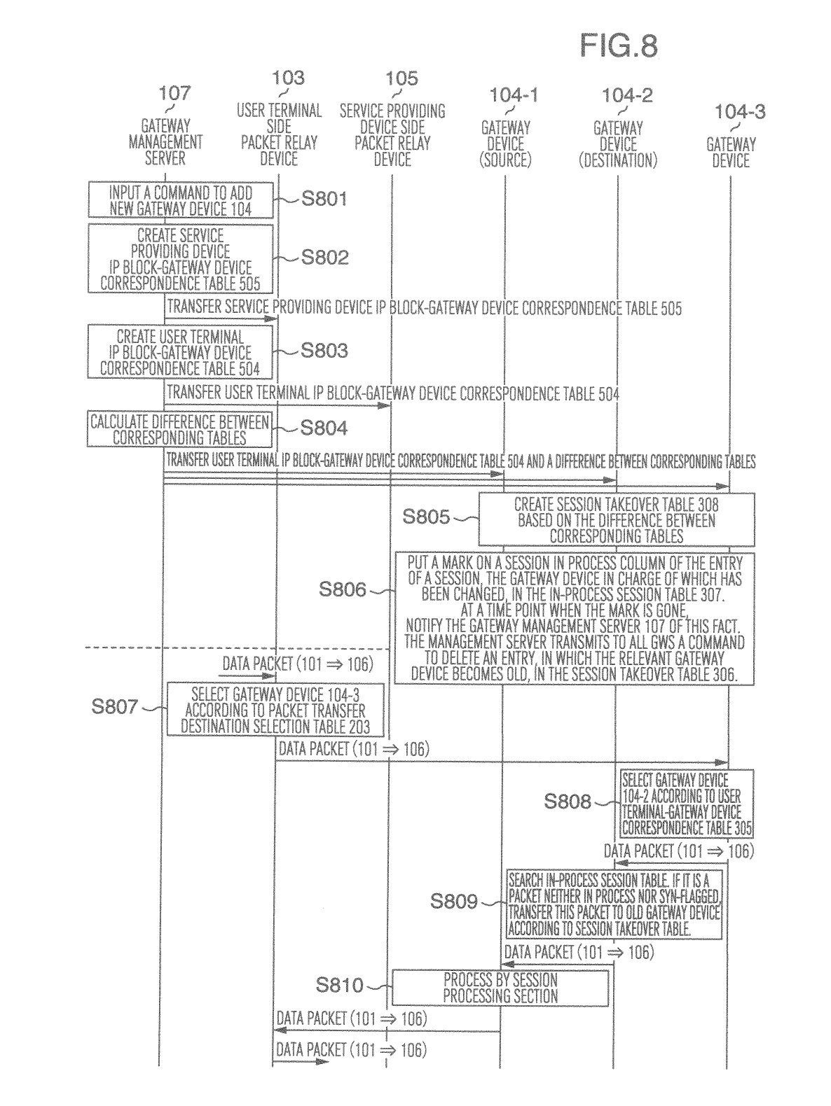

Next, the processing content when the gateway device 104 is added is described FIG. 8 shows an example of the sequence in adding the gateway device 104. In adding the gateway device 104, the gateway device 104 is coupled between the user terminal side packet relay device 103 and the service providing device side packet relay device 105 via a network, and subsequently a command to add the relevant gateway device 104 is input to the gateway management server 107 (S801). Upon receipt of the command, the gateway management server 107 creates various kinds of tables again (S802, S803), and calculates a difference between the old version and new version of the user terminal IP block-gateway device correspondence table 504 (S804). In adding a server, an adequate number of entries are selected from the user terminal IP block and the service providing device IP block and these entries are included in a range which the gateway device 104 to be newly added is in change of thereby changing the gateway device in charge. At this time, this change is made by selecting a gateway device in charge of approximately the same number of entries as the number of entries which other gateway device 104 is in charge, thereby securing that uniform distribution is carried out also in the distribution rule after the change.

The service providing device IP block-gateway device correspondence table 505 is distributed to the user terminal side packet relay device 103 and the user terminal IP block-gateway device correspondence table 504 is distributed to the service providing device side packet relay device 105, and the respective tables are managed as the packet destination selection table 203 in the respective packet relay devices 103, 105. To each gateway device 104, the user terminal IP block-gateway device correspondence table 504 together with a difference between the old version and new version thereof are transmitted. Upon receipt of this information, each gateway device 104 updates the user terminal-gateway device correspondence table 305 and also adds an entry to the session takeover table 306 based on the difference (S805). This entry indicates that from which gateway device 104 in charge to which gateway device 104 in charge the gateway device in charge of a certain user terminal IP block has been changed.

Moreover, each gateway device 104 puts a mark on a “session in process” column of an entry of a session, the gateway device in charge of which has been changed, in the in-process session table 307. This mark is required to delete an unnecessary entry in the session takeover table 306. That is, the need to transfer a packet to the gateway device formerly in charge is eliminated at a time point when a session in process is gone and therefore the relevant entry in the session takeover table 306 needs to be deleted. This can be done as follows (S806): at a time point when all the marks indicative of the session in process are gone in the in-process session table 307 in each gateway device 104, each gateway device 104 notifies the gateway management server 107 of this fact, and then the management server transmits to all the gateway devices 104 a command to delete an entry in the session takeover table 306, the entry indicating that the relevant gateway device 104 is formerly in charge.

The lower half of FIG. 8 shows the flow of packets when the gateway device 104 is added. Here shows an example when the gateway device 104-2 is added and accordingly the gateway device 104 in charge of a session, which is in process in the gateway device 104-1, is changed to the gateway device 104-2.

When a packet is transferred to the gateway device 104-3 according to the packet destination selection table of the user terminal side packet relay device 103 (S807) and is further transferred to the gateway device 104-2 according to the user terminal-gateway device correspondence table of the gateway device 104-3 (S808), it is determined according to the flow chart of FIG. 4 whether the packet is associated with a session in process in the relevant gateway device. Here, because the packet is neither in process nor a session initiation packet, the packet is transferred to the gateway device 104-1 formerly in charge according to the session takeover table (S809). Then, the session processing is continued in the gateway device 104-1 (S810). Thus, it can be seen that use of the session takeover table 306 and the in-process session table 307 makes it possible to correctly continue the processing even when the gateway device 104 in charge has been changed during session processing.

Also when the gateway device 104 is deleted, the same processing as with the addition of the gateway device 104 is carried out. However, the gateway device 104 to be deleted will be stopped after waiting all the sessions in process in a gateway device to be deleted to be completed.

In this manner, the processing of a session in process is carried out by the gateway device 104 in charge before the gateway device in charge is changed to another gateway device 104, so that the need to move the session in process itself between the gateways is eliminated and a session information moving cost involved in adding/deleting a gateway device is eliminated, and additionally the session information of the upper layer needs not be managed on the load distribution system side, thereby allowing an application-independent load distribution system to be constructed.

Moreover, for example, when the processing temporarily concentrates on a specific gateway device 104, the uniformity of load distribution may collapse. Then, the number of the sessions reaching the gateway device 104 can be reduced by reducing the number of IP blocks which the specific gateway device 104 is in charge of. In order to achieve this, in this embodiment one gateway device is permitted to take charge of a plurality of IP blocks. For this reason, an increase or decrease in the allocation of IP blocks to the gateway device 104 can be expressed as modification of the table similar to the case of the addition/deletion of the gateway device 104 and therefore the procedure described heretofore also makes it possible to equalize the deviations of a load.

As described above, according to the embodiment, a basic function which a typical router has and a function which a target for load distribution has are combined to realize one load distribution function. Thereby, the distribution by means of an inexpensive and high-speed hardware and the distribution based on a flexible and complicated software analysis can be combined and a scalable performance expansion can be realized. In addition, making redundant the section performing primary allocation by utilizing a redundancy function of a router is easy as compared with the use of a sophisticated load balancer, and as a result, the cost involved in resolving a single point of failure can be reduced.

### Embodiment 2

In this embodiment, an example of realizing load distribution without using the gateway management server 107 is described.

In order to realize this, the tables assumed to be included in the gateway management server 107 in the Embodiment 1 may be placed in all the gateway devices 104 and also the communication (a command to delete the session takeover table 306, and the like) via the gateway management server 107 may be changed to the direct communication between the gateway devices 104.

The whole system configuration of the Embodiment 2 is the one made by removing the gateway management server 107 from the configuration of the Embodiment 1 shown in FIG. 1. Moreover, each gateway device 104 has the tables shown in FIG. 5 in addition to the configuration shown in FIG. 3.

In the Embodiment 1, a method of distributing the tables created in the gateway management server 107 to each gateway device 104 is taken, while in this embodiment, an administrator will register the user terminal IP block table 501, the GW in-charge table 502, and the service providing device IP block table 503 with each gateway device. However, in a later-described procedure to add the gateway device 104, these tables are copied to the added gateway device 104. Therefore, a procedure is taken wherein in the initial state the setting is made for one gateway device 104 and then other gateway devices 104 are sequentially added. Thus, there is no need to copy the table information to a large number of gateway devices 104 by an administrator.

In the state where the gateway device 104 is neither added nor deleted after the tables are set once, completely the same operation as that of the Embodiment 1 is carried out. That is, each gateway device carries out packet processing according to the flow chart shown in FIG. 4, and the flow of packets is shown as in the sequence diagram shown in FIG. 7.

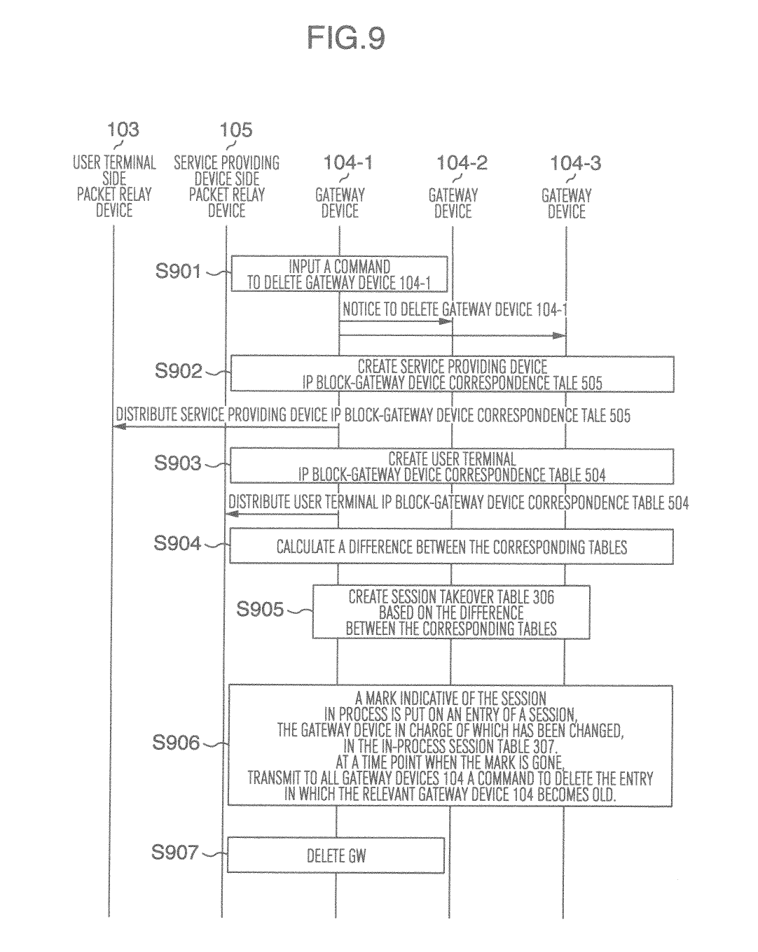

In the addition/deletion of the gateway device 104, the following point differs from the Embodiment 1. Here, with reference to FIG. 9, a procedure to delete the gateway device 104 is described. First, the gateway device 104 to be deleted is determined, and a delete command is input to this gateway device 104 (S901). FIG. 9 shows an example of deleting the gateway device 104-1. The gateway device 104-1 transmits to all the other gateways a notice to delete the gateway device 104-1. Then, the gateway device 104-1 to be deleted and the gateway devices 104-2, 104-3 having received this notice create their own service providing device IP block-gateway device correspondence table 505 (S902), create their own user terminal IP block-gateway device correspondence table 504 (S903), and calculate a difference between the old version and new version thereof (S904). Then, each gateway device creates the session takeover table 306 based on this difference (S905). In addition, a mark indicative of the session in process is put on the entry of a session, the gateway device in charge of which is to be changed, in the in-process session table 307. Any gateway device 104 may distribute the tables to the user terminal side packet relay device 103 and the service providing device side packet relay device 105, but here assume the gateway device 104-1 to be deleted distributes the tables.

At a time point when all the marks indicative of the session in process are gone in the in-process session table 307 in each gateway device 104, each gateway device 104 transmits to all the gateway devices 104 a command to delete the entry in which the relevant gateway device 104 becomes old (S906). At a time point when all the sessions in process are gone, the gateway device 104-1 to be deleted can be physically deleted from the system (S907).

In this procedure, there are two kinds of methods of determining a new gateway device in charge when the gateway device 104 has been deleted. The first method is a method of distributing an IP block, which a device to be deleted was in charge of to other gateway device using a non-deterministic calculation, such as using random numbers. In this method, a notice to delete the gateway device 104 includes the whole of the in-charge gateway device table 502 or a difference between the old version and new version thereof, so that a new in-charge gateway device allocation is distributed to all the gateway devices. In the second method, each gateway device 104 deterministically calculates a new gateway device allocation using a hash value or the like, respectively. In this method, although only the gateway device 104 to be deleted may be transmitted as the notice to delete the gateway device 104, the calculation carried out by each gateway device is costly.

Because the gateway management server 104 is not used as with this embodiment, a single point of failure on the system can be removed and the availability of the whole system can be improved.

The specification and drawings are, accordingly, to be regarded in an illustrative rather than a restrictive sense. It will, however, be evident that various modifications and changes may be made thereto without departing from the spirit and scope of the invention(s) as set forth in the claims.

We claim:

1. A gateway system comprising a first packet clay device and a plurality of gateway devices,
wherein the first packet relay device includes:
a packet processing section which determines the gateway device serving as a destination of a packet received via a network based on destination information of the packet, and
a packet transmission/reception section which transfers the packet to the gateway device, which is determined as the destination by the packet processing section, via a network,
wherein the gateway device includes:
a packet processing section which, based on transmission source information of a packet received via a network, determines a gateway device in charge of processing the packet; and
a packet transmission/reception section which, if the gateway device in charge of processing the packet is determined as other gateway device, transfers the packet to the other gateway device.

2. The gateway system according to claim 1, further comprising a second packet relay device,
wherein the packet processing section of the gateway device determines a gateway device in charge of processing a packet transferred via a network from the second packet relay device, based on destination information of the packet.

3. The gateway system according to claim 2,
wherein the packet processing section of the first packet relay device transfers to the gateway device a packet received from a user terminal, and
wherein the packet processing section of the second packet relay device transfers to the gateway device a reply packet in response to a packet transmitted from the user terminal and received from a server.

4. The gateway system according to claim 1,
wherein the first packet relay device includes packet destination information indicative of a correspondence between destination information of a packet and information for identifying a gateway device serving as a destination of the packet,
wherein the packet processing section of the first packet relay device determines a destination of the packet based on the packet destination information,
wherein the gateway device includes information on gateway devices in charge of processing a packet indicative of a correspondence between transmission source information of a packet and information for identifying a gateway device in charge of processing the packet, and
wherein the packet processing section of the gateway device determines a gateway device in charge of processing a packet based on the information on gateway devices in charge of processing a packet.

5. The gateway system according to claim 1,
wherein the packet processing section of the gateway device determines whether or not a received packet is a packet associated with a session in process in its own gateway device, based on session information included in the packet, and
if the received packet is determined as not the packet associated with the session in process in its own gateway device, the packet processing section of the gateway device determines a gateway device in charge of processing the packet based on the transmission source information of the packet.

6. The gateway system according to claim 1,
wherein the gateway device includes gateway device takeover information including information indicating that a gateway device in charge of processing the packet for each transmission source information of the packet has been changed,
wherein if the gateway device in charge of processing the packet is determined as its own gateway device based on transmission source information of a received packet, the packet processing section of the gateway device determines whether or not the packet is a packet indicative of a start of a session, and
wherein if the packet is determined as not the packet indicative of the start of a session, the packet processing section of the gateway device determines a gateway device serving as a destination of the packet based on the gateway device takeover information.

7. The gateway system according to claim 1, further comprising a management server coupled to a plurality of gateway devices via a network,
wherein the management server includes:
information on gateway devices in charge of processing a packet indicative of a correspondence between transmission source information of a packet and information for identifying a gateway device in charge of processing the packet; and
a transmission/reception section transmitting the information on gateway devices in charge of processing a packet to the gateway device, and
wherein the packet processing section of the gateway device determines a gateway device in charge of processing the packet based on the information on gateway devices in charge of processing a packet received from the management server.

8. The gateway system according to claim
wherein the transmission/reception section of the management server transmits gateway device takeover information including information indicating that a gateway device in charge of processing a packet for each transmission source information of a packet has been changed,
wherein if the gateway device in charge of processing the packet is determined as its own gateway device based on transmission source information of a received packet, the packet processing section of the gateway device determines whether or not the packet is a packet indicative of a start of a session, and
wherein if the packet is determined as not the packet indicative of the start of a session, the packet processing section of the gateway device determines a gateway device serving as a destination of the packet based on the gateway device takeover information.

9. A gateway device coupled to each other with a plurality of gateway devices via a network including:
information on gateway devices in charge of processing a packet indicative of a correspondence between transmission source information of a packet and information for identifying a gateway device in charge of processing the packet;
a packet processing section which determines a gateway device in charge of processing a packet received via the network based on the information on gateway devices in charge of processing a packet; and
a packet transmission/reception section which, if the gateway device in charge of processing the packet is determined as other gateway device, transfers the packet to the other gateway device.

10. The gateway device according to claim 9,
wherein the packet processing section determines whether or not a received packet is a packet associated with a session in process in its own gateway device, based on session information included in the packet, and
if the received packet is determined as not the packet associated with the session in process in its own gateway device, the packet processing section of the gateway device determines a gateway device in charge of processing the packet based on the transmission source information of the packet.

11. The gateway device according to claim 9, further including gateway device takeover information including information indicating that a gateway device in charge of processing a packet has been changed for each transmission source information of a packet,
wherein if the gateway device in charge of processing the packet is determined as its own gateway device based on transmission source information of a received packet, the packet processing section determines whether or not the packet is a packet indicative of start of a session, and
wherein if the packet is determined as not the packet indicative of the start of a session, the packet processing section of the gateway device determines a gateway device serving as a destination of the packet based on the gateway device takeover information.

12. The gateway device according to claim 9, the gateway device being coupled to a first packet relay device and a second packet relay device via a network,
wherein the packet processing section
searches the information on gateway devices in charge of processing a packet for transmission source information coinciding with transmission source information of a packet received from the first packet relay device, and
determines a gateway device corresponding to the searched transmission source information as a gateway device in charge of processing the packet, and
wherein the packet processing section
searches the information on gateway devices in charge of processing a packet for transmission source information coinciding with destination information of a packet received from the second packet relay device, and
determines a gateway device corresponding to the searched transmission source information as a gateway device in charge of processing the packet.

13. A load distribution method in a gateway system comprising a packet relay device and a plurality of gateway devices, the method comprising the steps of:
in the packet relay device, transferring a packet received via a network to a gateway device which is determined based on destination information of the packet;
in the gateway device, determining a gateway device in charge of processing the packet based on transmission source information of the packet; and
if the gateway device in charge of processing the packet is determined as other gateway device, transferring the packet to the other gateway device.

14. The load distribution method according to claim 13, the method further comprising the steps of:
in the gateway device, determining whether or not the packet received via the network is a packet associated with a session in process in its own gateway device, based on session information included in the packet, and
if the received packet is determined as not the packet associated with the session in process in its own gateway device, determining a gateway device in charge of processing the packet based on the transmission source information of the packet.

15. The load distribution method according to claim 13,
wherein the method further comprising the steps of:
in the gateway device, if the gateway device in charge of processing the packet is determined as its own gateway device based on transmission source information of a packet received from the network, determining whether or not the packet is a packet indicative of a start of a session; and
if the packet is determined as not the packet indicative of the start of a session, determining a gateway device serving as a destination of the packet based on transmission source information of the packet.

16. The load distribution method according to claim 15,
wherein the gateway device serving as the destination is a gateway device currently processing a session associated with the packet.
